(19) United States
(12) Patent Application Publication
(10) Pub. No.: US 2025/0233497 A1
(43) Pub. Date: Jul. 17, 2025

(54) ELECTROMAGNETIC MOTOR

(71) Applicant: Bakhyt TLESHOV, Almaty (KZ)

(72) Inventor: Bakhyt TLESHOV, Almaty (KZ)

(21) Appl. No.: 18/838,864

(22) PCT Filed: Jun. 11, 2022
(86) PCT No.: PCT/KZ2022/000004

§ 371 Date: Aug. 15, 2024

(30) Foreign Application Priority Data
Feb. 28, 2022 (KZ) 2022/0124.1

(51) Int. Cl. H02K 53/00; H02K 7/08; H02K 7/20

(52) U.S. Cl. CPC H02K 53/00; H02K 7/08; H02K 7/20

(57) ABSTRACT

The invention relates to electrical engineering. In the area of physics of magnetism of engine building. Creation of an engine capable of creating mechanical energy due to a magnetic field. Use this mechanical energy to generate electricity, in mechanical engineering, aircraft building and shipbuilding, as well as in all industries where mechanical energy is used. The objective of the invention is to obtain a large lifting force as an engine based on magnetic fields. The essence of the invention lies in the fact that the electromagnetic motor, consisting of a housing, shaft, rotor, and stator of magnets. In which the rotor, stator, shaft, and body in the form of a frame are made of non-magnetizable material. The shaft consists of a rotating shaft and a fixed axle. The rotating shaft is mounted on a fixed axle with the help of bearings. The rotor consists of four tiers, where the first upper tier is made in the form of a domed disk containing permanent magnets. All tiers are made in the form of a disk with cone-shaped cylinders of different diameters planted on them with a decrease in height. The lower part of each cone-shaped cylinder has semicircular holes and the diameter of the lower part of the cone-shaped cylinder corresponds to the diameter of the disk of the corresponding tier. The disks contain permanent magnets arranged in a spiral, the poles of which of all four disks are directed upwards with the outgoing side of the magnetic lines of force or vice versa. While the cone-shaped cylinders contain permanent magnets, the poles of the magnets of the cone-shaped cylinders are directed inward by the outgoing side of the magnetic lines of force or vice versa. Inside the cone-shaped magnetic cylinders there are triangular or crescent-shaped magnetic repulsors of force lines, the poles of which are opposite to the poles of the cone-shaped magnetic cylinder. One of the pushers is located opposite to the hole in the cylinder. On the upper dome-shaped disk, the magnetic field lines are directed downward, into the inside of the dome or vice versa. The hole from where the rotating shaft of the rotor comes out is also closed by a permanent magnet, this magnet is built into the rotating shaft itself at the level of the domed disk. And it is made with the possibility of rotation together with the said shaft. The rotor rotates on a fixed shaft, in which the fixed magnets are located at the levels with the disks. The whole structure is rigidly fastened with a nut on a rotating shaft. The whole structure is rotated by a DC or AC motor. The electric motor is fixed on the frame.

### CROSS-REFERENCE TO RELATED APPLICATIONS

This application is the U.S. national phase of International Application No. PCT/KZ2022/000004 filed Jun. 11, 2022, which designated the U.S. and claims priority to KZ 2022/0124.1 filed Feb. 28, 2022, the entire contents of each of which are hereby incorporated by reference.

### TECHNICAL FIELD

The invention relates to electrical engineering, in the area of physics of magnetism of engine building. Creation of an engine capable of creating mechanical energy due to a magnetic field and taking advantage of this mechanical energy to generate electricity, in mechanical engineering, aircraft building and shipbuilding, as well as in all industries where mechanical energy is used.

### BACKGROUND

An analog of RU 2117379 C1, Aug. 10, 1998, is known, a magnetic motor containing permanent magnets installed rigidly and sequentially in at least two rows on two relative to each other movable non-magnetic elements. At the same time, large permanent magnets with vertical magnetization of the first element are turned by their poles of the same name towards permanent magnets with horizontal magnetization of the second element. Opposite poles of each permanent magnet with horizontal magnetization of the said second element are arranged in one row parallel to the row of like poles of large permanent magnets facing them with vertical magnetization of the first element, and the connection of the magnetic fields of the permanent magnets of both elements is made through an air gap with the possibility of deformation of the magnetic fields and rotation by a certain angle of neutral sections of permanent magnets. At the same time, small permanent magnets with vertical magnetization are introduced into it. In the same direction as the magnetization of large permanent magnets. They are installed on the first element between large permanent magnets with their uniform alternation through one, with air gaps between them and with the possibility of their movement within the height of large permanent magnets.

The disadvantage of this device is the complexity of its construction and the impossibility of obtaining lifting force as an engine based on magnetic fields.

### SUMMARY

The objective of the invention is to obtain a large lifting force as an engine based on magnetic fields.

The essence of the invention lies in the fact that the electromagnetic motor, consisting of a housing, shaft, rotor, and stator of magnets. In which the rotor, stator, shaft, and body in the form of a frame are made of non-magnetizable material. The shaft consists of a rotating shaft and a fixed axle. The rotating shaft is mounted on a fixed axle with the help of bearings. The rotor consists of four tiers, where the first upper tier is made in the form of a domed disk containing permanent magnets. All tiers are made in the form of a disk with cone-shaped cylinders of different diameters planted on them with a decrease in height. The lower part of each cone-shaped cylinder has semicircular holes and the diameter of the lower part of the cone-shaped cylinder corresponds to the diameter of the disk of the corresponding tier. The disks contain permanent magnets arranged in a spiral, the poles of which of all four disks are directed upwards with the outgoing side of the magnetic lines of force or vice versa. While the cone-shaped cylinders contain permanent magnets, the poles of the magnets of the cone-shaped cylinders are directed inward by the outgoing side of the magnetic lines of force or vice versa. Inside the cone-shaped magnetic cylinders there are triangular or crescent-shaped magnetic repulsors of force lines, the poles of which are opposite to the poles of the cone-shaped magnetic cylinder. One of the pushers is located opposite to the hole in the cylinder. On the upper dome-shaped disk, the magnetic field lines are directed downward, into the inside of the dome or vice versa. The hole from where the rotating shaft of the rotor comes out is also closed by a permanent magnet, this magnet is built into the rotating shaft itself at the level of the domed disk. And it is made with the possibility of rotation together with the said shaft. The rotor rotates on a fixed shaft, in which the fixed magnets are located at the levels with the disks. The rotor rotates by a DC or AC motor. The electric motor is fixed on the frame.

Uniqueness of the device is that, during rotation, the deformation of the magnetic fields occurs, and the output of the lines of force of the magnetic fields outside of the device. And these deformed magnetic fields generate lift.

### BRIEF DESCRIPTION OF THE DRAWINGS

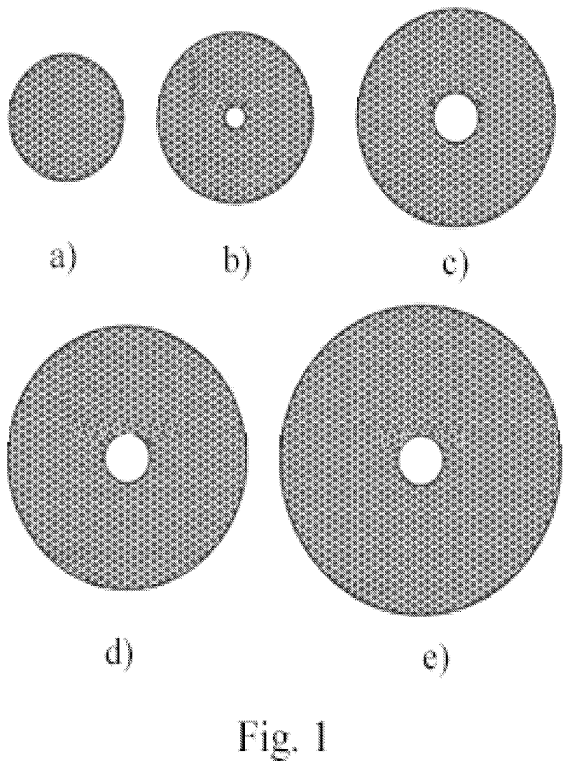

In FIG. 1a), b), c), d), e) shows the magnetic disks of the rotor made of non-magnetic material in which permanent magnets of different diameters are located.

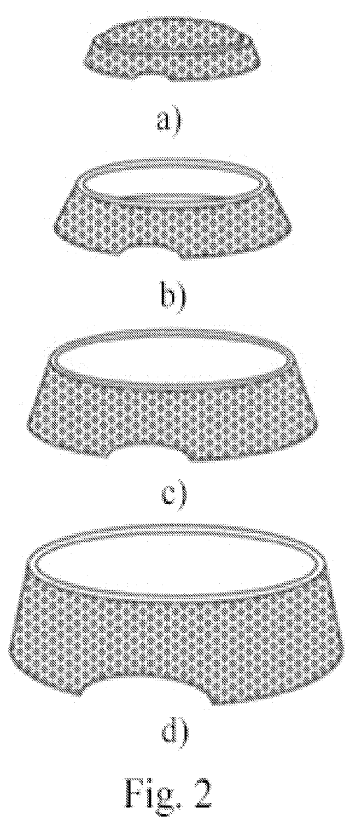

In FIG. 2a), b), c), d) side view of magnetic cone-shaped cylinders is shown.

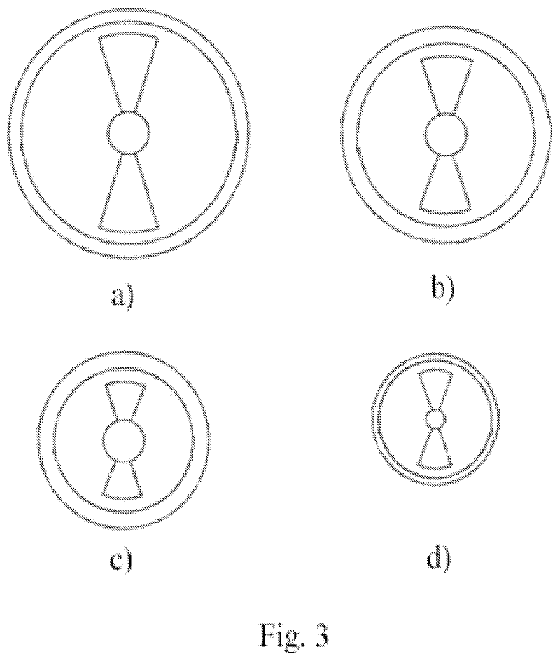

In FIG. 3a), b), c), d) top view of magnetic cone-shaped cylinders is shown.

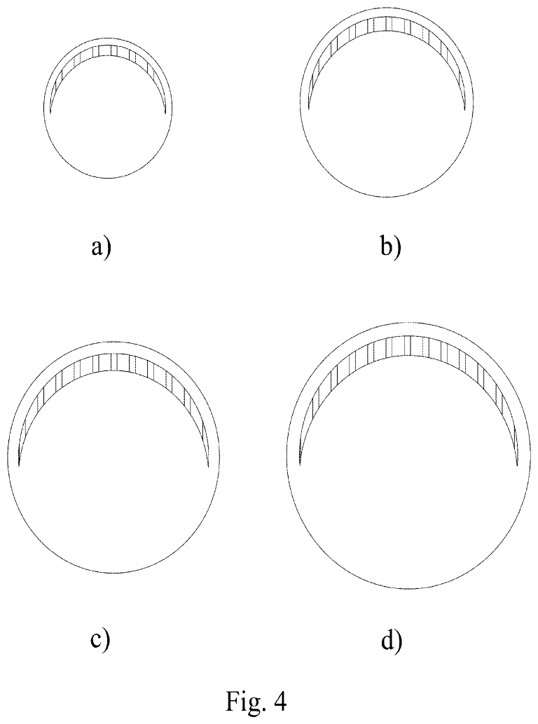

In FIG. 4a), b), c), d) shows magnetic trapezoidal conical cylinders with repulsors, top view.

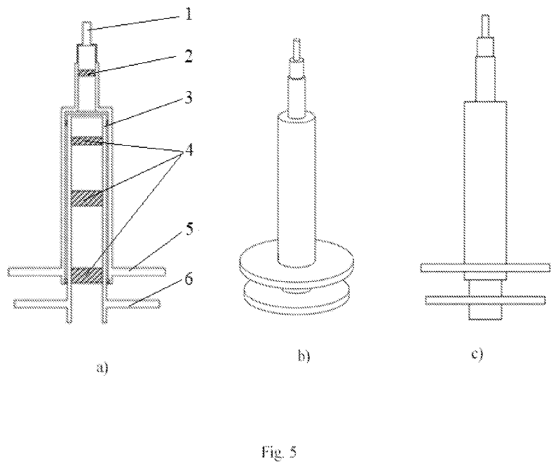

In FIG. 5a) shafts are shown in sections. In FIG. 5b) the shafts are shown in three-dimensional form, 5c) the shafts are shown in a side view.

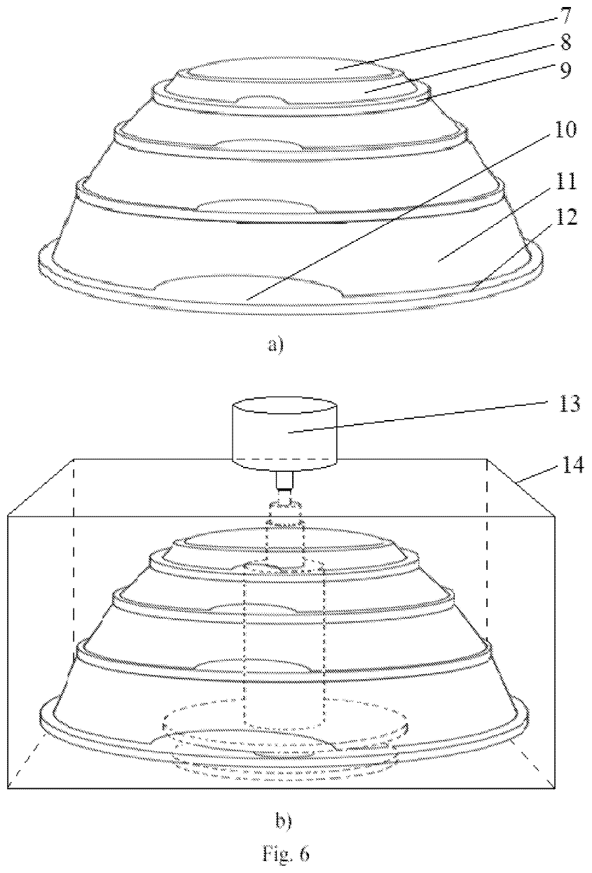

In FIG. 6a) is shown the device as a whole without an electric motor, 6b) shows the device as a whole with an electric motor and frame.

### DETAILED DESCRIPTION

### The Device Consists of the Following Elements:

1. outer shaft; 2. magnet inside the shaft at the level of the cover; 3. bearing; 4. fixed magnets on a fixed shaft; 5. movable shaft; 6. fixed shaft; 7. cap convex disc with opposite pole magnet; 8. the smallest magnetic trapezoidal cone cylinders; 9. the smallest magnetic discs; 10. openings for the release of magnetic fields; 11. the largest magnetic trapezoidal cone cylinders; 12. the largest magnetic disks; 13. electric motor; 14. frame that holds the entire structure.

The engine consists of four permanent magnetic disks of different diameters, as in FIG. 1 and the fifth disk of a semicircular cover with the opposite pole. A magnetic cone-shaped cylinder is placed on each magnetic disk, with small semicircular holes on the bottom of the cylinder wall as in FIG. 2, let's call them magnetic blocks, the case is made of non-magnetizable materials, and an electric motor is used for spinning as in FIG. 6. All blocks are mounted on a shaft made of non-magnetic material, which sits on a fixed shaft through two bearings, and rotates around this shaft, as in FIG. 5. Each block differs in size from each other, the largest one is at the bottom, and the next one, in size reduction, is placed on top of each other as in FIG. 6 and is pulled together from above with a nut on the shaft. All blocks are installed on the shaft and attached to the electric motor.

Four magnetic disks located between magnetic cone-shaped cylinders. Single pole, magnetic lines of force on the disks directing upwards or downwards and only the last small domed disk at the very top with the opposite pole to the rest of the disks. The pole of the cone-shaped magnetic cylinder coincides with the poles of the four discs and is directed by the same pole inward or backward.

Tightly spaced permanent magnets generate magnetic fields and, when rotated, the lines of force of the magnetic fields are deformed and removed from the blocks. Since they must close, we direct the magnetic field through a narrow passage inward for closing, through fixed magnets in a fixed shaft, which makes up the lifting force. When rotating, the lines of force cannot close on a spinning magnet. In a stationary position, when the engine is not spinning, the lines of force come out of each magnet and close on the same magnet and do not show lifting force. The device uses permanent magnets. You can get the same or even stronger results using electromagnets.

In the cone-shaped magnetic cylinders, triangular or crescent-shaped magnetic repulsors of force lines are located inside, the poles of which are opposite to the poles of the cone-shaped magnetic cylinder. One of the repulsors is located exactly opposite to the hole in the cylinder, its task is to push the magnetic lines of force out, and the task of the second one is to compress the magnetic lines of force to the walls of the block. On the last domed disk, the hole on top is also closed with a magnet, but its magnet is built into the inside of the rotating shaft. The fixed shaft also has holes inside with a diameter of 41 mm, where three magnets with a diameter of 40 mm and a thickness of 10 and two 20 mm each are inserted at the level of disks with round magnets. They are not mobile and serve as the delivery of magnetic lines of force in the capacity of the discs. In the section, the magnets are shaded, the hemisphere shape of the engine is closed on all sides by magnets, and they also rotate, except for the fixed magnets, inside the fixed shaft and the hole on the cylinder wall.

### The Device Works as Follows:

With strong rotation, the magnet does not let magnetic lines of force pass through itself. When we start to spin the engine due to the electric motor, the whole hemisphere begins to rotate. Magnetic field lines under the action of centrifugal force begin to deform from the center to the edges and press against the walls of the cone-shaped magnetic cylinders, forming a vortex with a denser magnetic field. Under the action of repulsors, the magnetic lines of force that have flown out from the lower hole of the blocks continue to move in a circle from the outside of the sphere, that is, the blocks, in a vortex again trying to get inside to close, but they are not allowed there by the moving magnetic walls of the cylinders of the blocks and the magnetic lines gradually deform going downwards. They strive to get through the fixed magnets inside the fixed shaft from below, into the inside of the blocks, since there they are formed there and must be closed.

By adjusting the size of these fixed magnets and the outlets on the cylinder sides of the blocks, and the speed of rotation of the engine, we regulate the lift force of the engine. When the magnetic lines deform and fly out of the containers, they look for a hole with a fixed magnet in order to again close inside the blocks. From above the sphere, the movement of magnetic lines does not exert pressure on the sphere since the deformed lines begin to circle in a vortex around the hemisphere or blocks. All pressure is applied from below to the inlet fixed magnets, which creates lift. The moving magnets do not pass magnetic lines through themselves, even if they pass, then in a minimal amount.

If we run the deformed magnetic lines inside the blocks not through the bottom of the structure, but from the side, then the entire structure moves not only up and down, but also horizontally. This is easy to do if the motor is assembled on electromagnets, during rotation, turn off the section of the magnet in the gap opposite, in the direction of the motor.

1. (canceled)

2. A electromagnetic motor consisting of four magnetic disks of different sizes; three disks have a hole in the middle, also, the electromagnetic motor consists of three magnetic truncated cones of different sizes and a fourth magnetic cone at the very top, on one side of the surface of each truncated cones and on the upper cone there is a hole of a semicircular type, on the disks there are magnetic guides that are triangular on one edge and semicircular on the other, that fit on both sides of these holes, the largest truncated cone sits on the largest disk with a large base, a second disk rests on the small base of this cone, the second truncated cone sits on this disk, the third disc is placed on it, the third truncated cone sits on the third disc, the fourth disk rests on it, and the upper cone sits on it.

3. The electromagnetic motor of claim 2, this whole structure of the electromagnetic motor is called my engine, which we have on the shaft, the shaft passes vertically through the holes in the disks and exits from the top of the upper cone, this shaft is planted through bearings on a fixed axis, and revolves around it, along with my engine, the fixed axis itself is hollow inside where fixed magnets are inserted at the levels of the disks of my engine with the north pole down, the magnetic poles on all disks are arranged in the following order, the north poles point down the south poles up, on the lateral surfaces of all truncated cones, the north poles are located outside, and the south ones are located inside, this entire structure of my motor is rotated by an asynchronous motor located above my motor, mounted on a common housing, where the rotor of an asynchronous motor is fixed through an adapter with the movable shaft of my motor.

4. A electromagnetic motor comprising four magnetic disks of different sizes; three disks have a hole in the middle, also, the electromagnetic motor includes three magnetic truncated cones of different sizes and a fourth magnetic cone at the very top, on one side of the surface of each truncated cones and on the upper cone there is a hole of a semicircular type, on the disks there are magnetic guides that are triangular on one edge and semicircular on the other, that fit on both sides of these holes, the largest truncated cone sits on the largest disk with a large base, a second disk rests on the small base of this cone, the second truncated cone sits on this disk, the third disc is placed on it, the third truncated cone sits on the third disc, the fourth disk rests on it, and the upper cone sits on it.
